(19) United States
(12) Patent Application Publication
(10) Pub. No.: US 2025/0285120 A1
(43) Pub. Date: Sep. 11, 2025

(54) SYSTEM FOR AI PERMIT DATA GATHERING, AGGREGATION, ANALYSIS AND REPORTING

(71) Applicant: Charles Isgar, Scottsdale, AZ (US)

(72) Inventor: Charles Isgar, Scottsdale, AZ (US)

(21) Appl. No.: 18/601,105

(22) Filed: Mar. 11, 2024

(51) Int. Cl. G06Q 30/018; G06F 16/29

(52) U.S. Cl. CPC G06Q 30/018; G06F 16/29

(57) ABSTRACT

A system for AI permit data gathering, aggregation, analysis and reporting is provided. The system includes a server having a memory for storing permit data, a user computing device coupled to the server; and one or more public record servers accessible by the server. The system operates for using artificial intelligent software for gathering, aggregating, and analyzing permit and other public data corresponding to one or more properties and generating a corresponding report as requested by a user, including for user home renovation needs or for pure curiosity. The server, based on requests from the user computing devices, processes the information in accordance with a query of the user computing device that includes location data and provides locations of construction project types corresponding to the location data. The server may generate a report and send it to the user computing device in response to a request by a user.

### BACKGROUND OF THE INVENTION

### Technical Field

This invention generally relates to a system for reviewing building permits and the like, and more specifically to a system for using artificial intelligent software for gathering, aggregating, and analyzing permit and other public data corresponding to a properties of a selected community and generating a corresponding report as requested by a user, including data for property improvement needs and for general neighborhood activity reporting and engagement.

### State of the Art

Property, whether it is a new build, or another type of renovation takes time and also requires one or more permits in order to perform many types of construction on premises. These permits are generally available to the public, however, there does not exist a system that can aggregate and process the data in useable fashion for the general public based on the location of the user.

Accordingly, what is needed is a system for using artificial intelligent software for gathering, aggregating, and analyzing permit and other public data corresponding to one or more properties and generating a corresponding report as requested by a user.

### SUMMARY OF THE INVENTION

An embodiment includes a permit aggregating and reporting system comprising: a server having a memory for storing permit data; a user computing device coupled to the server; and one or more public record servers accessible by the server through the Internet, wherein the server is programmed to: to access the one or more public records servers through the Internet and gather the permit data and store the permit data in the memory of the server; couple the user computing device to the server in response to receiving and processing a signal that the user computing device has accessed the system by one of an app, a website or webapp operating on the user computing device; receive and process the location data from the user computing device and automatically determine the permit data that corresponds to the location data; send for display on the user computing device permit information including a map of the searched area with indicators identifying locations of where construction/renovation projects occurred matching the location data; and receive and process a signal from the user computing device including a selected indicator for a corresponding property and generate and send for display on the user computing device a report corresponding to the selected property.

Another embodiment includes a permit aggregating and reporting system comprising: a server having a memory for storing permit data; a user computing device coupled to the server; and a plurality of public record servers accessible by the server through the Internet, the plurality of public record servers including two or more of permit databases, social media commentary, home listings databases, builder databases, community databases, and overhead imagery, wherein the server is programmed to: to access the plurality of public records servers through the Internet and gather the permit data and store the permit data in the memory of the server; couple the user computing device to the server in response to receiving and processing a signal that the user computing device has accessed the system by one of an app, a website or webapp operating on the user computing device; receive and process the location data from the user computing device and automatically determine the permit data that corresponds to the location data; send for display on the user computing device permit information including a map of the searched area with indicators identifying locations of where construction/renovation projects occurred matching the location data; and receive and process a signal from the user computing device including a selected indicator for a corresponding property and using AI software generate and send for display on the user computing device a brief report corresponding to the selected property, wherein the brief report includes a status of all permits corresponding to the selected property.

The foregoing and other features and advantages of the invention will be apparent to those of ordinary skill in the art from the following more particular description of the invention and the accompanying drawings.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 a diagrammatic view of a permit aggregating and reporting system according to an embodiment;

FIG. 2 is a view of a location user interface for interaction with a permit aggregating and reporting system according to an embodiment;

FIG. 3 is a view of a query user interface for interaction with a permit aggregating and reporting system according to an embodiment;

FIG. 4 is a view of a results user interface for interaction with a permit aggregating and reporting system according to an embodiment;

FIG. 5 is a view of a report user interface for interaction with a permit aggregating and reporting system according to an embodiment;

FIG. 6 is a view of a user computing device operating a permit aggregating and reporting system regarding a specific project type according to an embodiment;

FIG. 7 is a view of a user computing device operating a permit aggregating and reporting system regarding a specific project type according to an embodiment;

FIG. 8 is a view of a user computing device operating a permit aggregating and reporting system regarding a specific project type according to an embodiment;

FIG. 9 is a flow chart depicting a method of generating a house buyer rating using a permit aggregating and reporting system according to an embodiment;

FIG. 10 is a view of a user computing device operating a permit aggregating and reporting system to generate a project type rating according to an embodiment;

FIG. 11 is a view of a user computing device operating a permit aggregating and reporting system to generate a home maintenance rating according to an embodiment;

FIG. 12 is a flow chart depicting a method of tracking permits using a permit aggregating and reporting system according to an embodiment; and

FIG. 13 is a flow chart depicting a method of generating and reporting a permit ladder sequence using a permit aggregating and reporting system according to an embodiment;

FIG. 14A is a view of a user computing device operating a permit aggregating and reporting system to search for construction and permits around a location according to an embodiment;

FIG. 14B is a view of a user computing device operating a permit aggregating and reporting system to display results of a search for construction and permits around a location according to an embodiment;

FIG. 14C is a view of a user computing device operating a permit aggregating and reporting system to display results of a search for construction and permits around a location according to an embodiment;

FIG. 14D is a view of a user computing device operating a permit aggregating and reporting system to display results of a search for construction and permits around a location according to an embodiment;

FIG. 14E is a view of a user computing device operating a permit aggregating and reporting system to display results of a search for construction and permits around a location according to an embodiment;

FIG. 14F is a view of a user computing device operating a permit aggregating and reporting system to display a report of a property according to an embodiment;

FIG. 14G is a view of a user computing device operating a permit aggregating and reporting system sending an alert regarding a permit according to an embodiment; and

FIG. 14H is a view of a user computing device operating a permit aggregating and reporting system to submit a complaint report on a neighbor home according to an embodiment.

### DETAILED DESCRIPTION OF EMBODIMENTS OF THE INVENTION

Embodiments of the present invention relate to a system for using artificial intelligent software for gathering, aggregating, and analyzing permit and other public data corresponding to one or more properties and generating a corresponding report as requested by a user. The system may include the use of a user computing device that may be a mobile computing device such as a smartphone, a tablet, a wearable, and the like; and/or the system may operate on any type of computing device as a downloadable application or even as a web application.

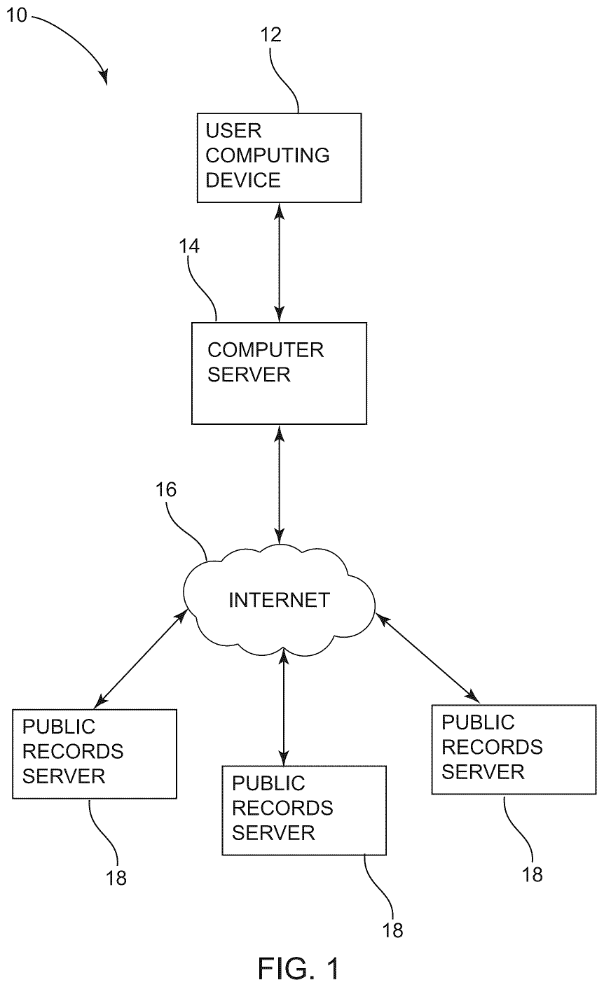

FIG. 1 depicts an embodiment of a permit aggregating and reporting system 10. The system 10 may include a user computing device 12 and a server 14, wherein the user computing device 12 is coupled to the computer server 14. This coupling may be a network connection, such as a wireless connection through an Internet connection, a Wi-Fi connection, a Bluetooth connection or the like, wherein the user computing devices 12 may communicate with and receive communication from the server 14. The user computing device 12 may be a desktop computer, a laptop, a tablet, a smartphone, wearable devices and the like. The server 14, in some embodiments, may be a computer server or a cloud-based infrastructure architecture. The system 10 may also include a plurality of public records servers 18, wherein the public records servers 18 are associated with municipalities such as towns, cities, counties, states and the like. The server 14 may be coupled to the public records servers 18 through the Internet 16.

The server 14 may include a memory storing various data. The memory of the server 14 may store permit data related to various construction types obtained through the Internet 16 connection to public records servers 18. The term “permit data” is not restricted to only information of permits, but also includes information related or connected to permits such as, but not limited to, a construction project with associated location of the construction project, permits issued for the construction project, time from permit application until permit was granted, time from granting of permit until the construction project was completed, contractor and/or subcontractors performing work on the construction project, and the like.

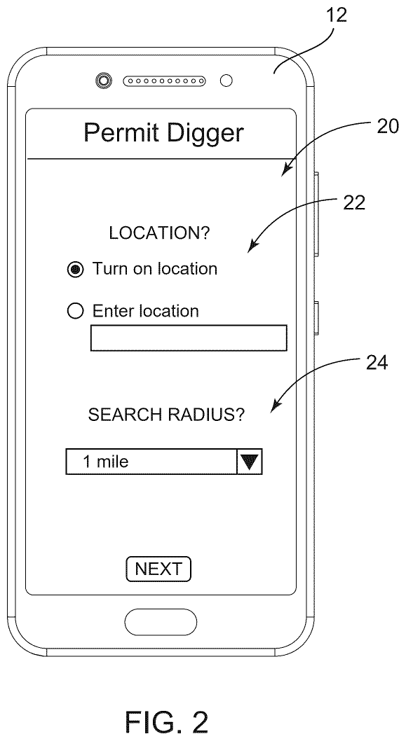

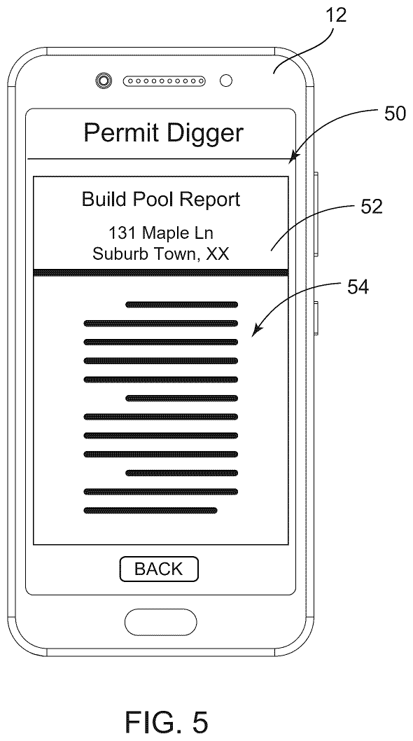

The user computing device 12 may be coupled to the server 14, and, referring to FIGS. 2-5, the server 14 may be programmed to access the public records servers 18 through the Internet 16 and scrape or otherwise gather permit data for each of the municipalities associated with the public records servers 18 and store the permit data in the memory of the server 14. The server 14 may be programmed to repeat this gathering of permit data from the public records servers 18 at predetermined times and/or increments to update the stored permit data from time-to-time. Additionally, other third-party search engines and systems may be utilized to gather other information associated with homes, buildings and the like that are available through other public websites and so forth. All of the databases and third-party search engines and systems are commonly referred to as public records servers in this specification, for example, and without limitation, public records server include public record databases including permit databases, social media commentary, home listings, builder databases, community databases, overhead imagery and the like.

The server 14 may be programmed to receive and process a signal that a user computing device 12 has accessed the system 10 such as by an app, website or web app on the user computing device 12. In embodiments, when the user computing device accesses the system 10 a location user interface 20 may be displayed on the user computing device 12, as shown in FIG. 2. The location user interface 20 may provide options for determining the location to be searched using location input item 22. Location input item 22 may include turning on the location services of the user computing device 12 or manually entering a location, such as an address, crossroads, zip code and the like. The location user interface 20 may also include an input for a search radius around the location entered. The user computing device may then be advanced to the next user interface, such as by selecting a “NEXT” button. The selecting of the “NEXT” button also stores location data that includes the location entered and the search radius for sending to the server 14. In some embodiments the location data is stored on the user computing device 12 until it is sent by the user in the following user interface.

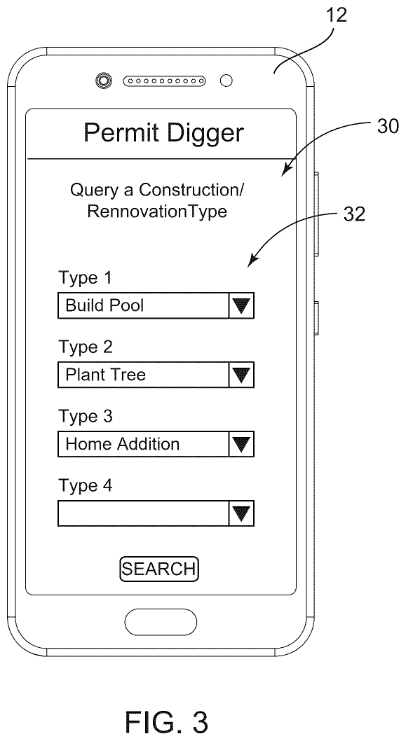

The user interface displayed on user computing device 12 after advancing from the location user interface 20 may be a query user interface 30, as depicted in FIG. 3. The query user interface 30 may include query input items 32 that allows the user to input on user computing device 12 construction/renovation types. In embodiments, the query user interface 30 depicts one or more query input items 32. These query input items 32 may include, without limitation, build pool, plant tree, home addition, new home build and so forth. The query input items 32 are depicted as drop-down menus that are prepopulated with construction types, but other input options may be utilized, such as radio buttons, text input options and the like. Once one or more query input items are entered, the user may then select the “SEARCH” button on the query user interface 30. The selection of the “SEARCH” button results in the location data and query data obtained from the query input items 32 to be sent to the server.

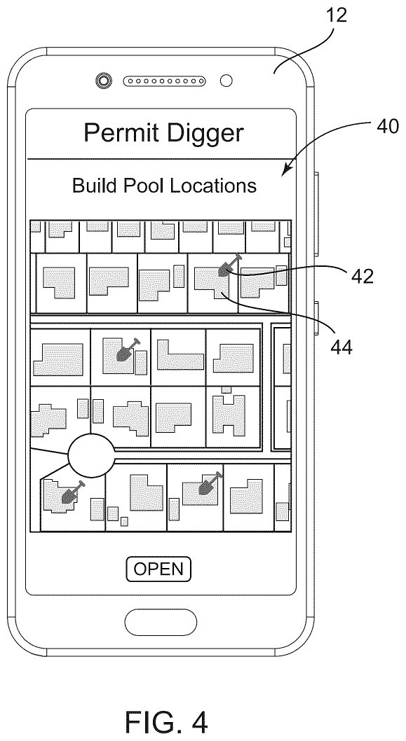

The server 14 may then be programmed to receive and process the location data and query data from the user computing device and automatically determine the permit data that corresponds to the location data and the query data. The server 14 may then be programmed to send for display on the user computing device permit information including a map of the searched area with indicators identifying locations of where construction/renovation projects occurred matching the query data, as shown in FIG. 4. A results user interface 40 is shown in FIG. 4, that includes map with indicator 42 identifying properties 44, such as homes, that the construction/renovation project occurred or is currently underway. The indicator 42 may be a selectable element that the user can select through the results user interface on the user computing device 12. In response to a user selecting a selectable element and indicating the selection be sent to the server 14 from the user computing device 12, the server 14 may also be programmed to receive and process a signal from the user computing device including the selected indicator 42 for the corresponding property 44 and generate and send for display on the user computing device 12 a report corresponding to the selected property 44. The user computing device 12 may display the report 52 on a report user interface 50. The report may include the address of the property 44 and details 54 of the construction/renovation project or projects that occurred at the property 44. The details 54 of the report 52 may include timing to complete projects, including time for permit to be granted and time until the permit is closed and project is completed. The details 54 may also include contractor and/or subcontractor information, cost information and aggregate the same to determine what contractors may be best in that area for a particular construction project type.

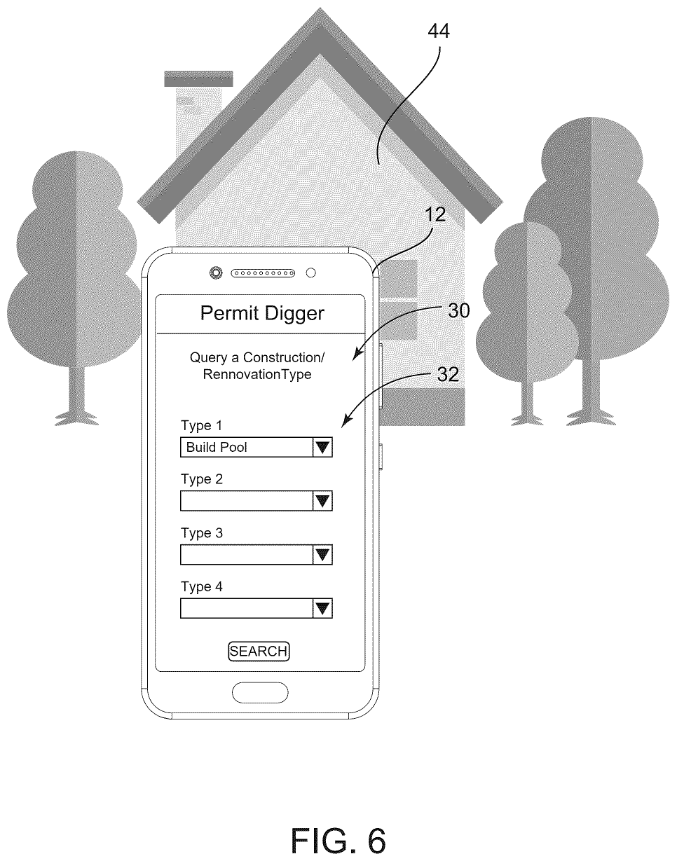

As an example, and not by way of limitation, FIGS. 6-8 depicts utilization of the system 10 according to an embodiment. In this embodiment, the user computing device 12 is operating with the location of the user computing device 12 turned on, thereby not requiring the entering of an address. The user computing device 12 may be located in front of the property and structure that the user is interested in obtaining information for. In this embodiment, the user computing device is depicting a query user interface 30 that includes query input items 32 that allows the user to input on user computing device 12 construction/renovation types. In embodiments, the query user interface 30 depicts one or more query input items 32 and that the user has selected a build pool query item 32 for the construction/renovation type. After selecting the input items 32, the user then select the “SEARCH” button on the query user interface 30.

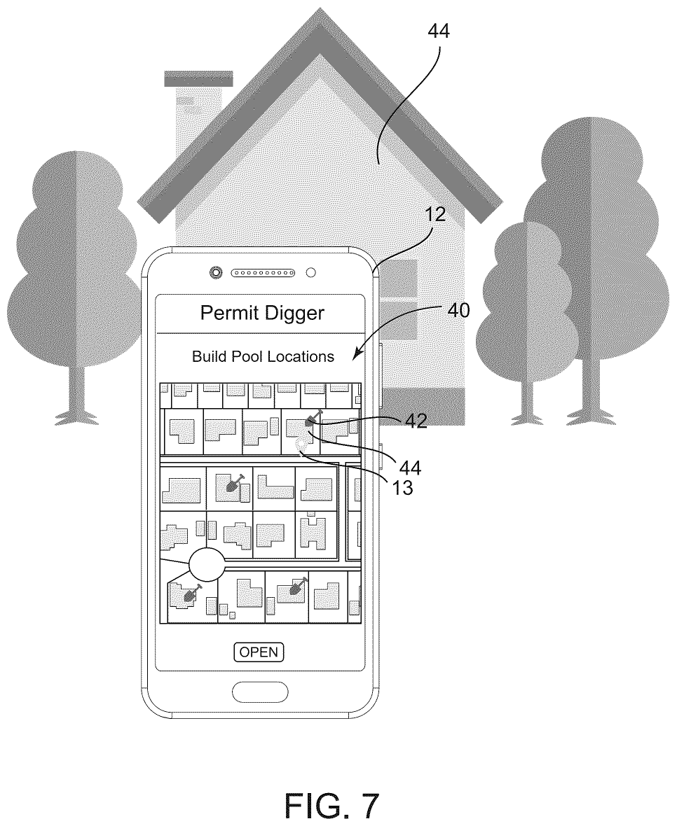

In response to selecting the “SEARCH” button, FIG. 7 depicts a results interface that is displayed on the user computing device 12 after the server 14 receives and processes the location data and query data from the user computing device 12, automatically determines the permit data that corresponds to the location data and the query data; and sends for display on the user computing device 12 permit information including a map of the searched area with indicators identifying locations of where construction/renovation projects occurred matching the query data. The map may also display a location indicator 13 of the user computing device 12 in relation to the mapped elements, as shown in FIG. 7. The results user interface 40 is shown in FIG. 4, that includes map with indicator 42 identifying properties 44, such as homes, that the construction/renovation project occurred or is currently underway. The indicator 42 may be a selectable element that the user can select through the results user interface on the user computing device 12. In response to a user selecting the selectable element 42 and indicating the selection be sent to the server 14 by pressing the “OPEN” button from the user computing device 12.

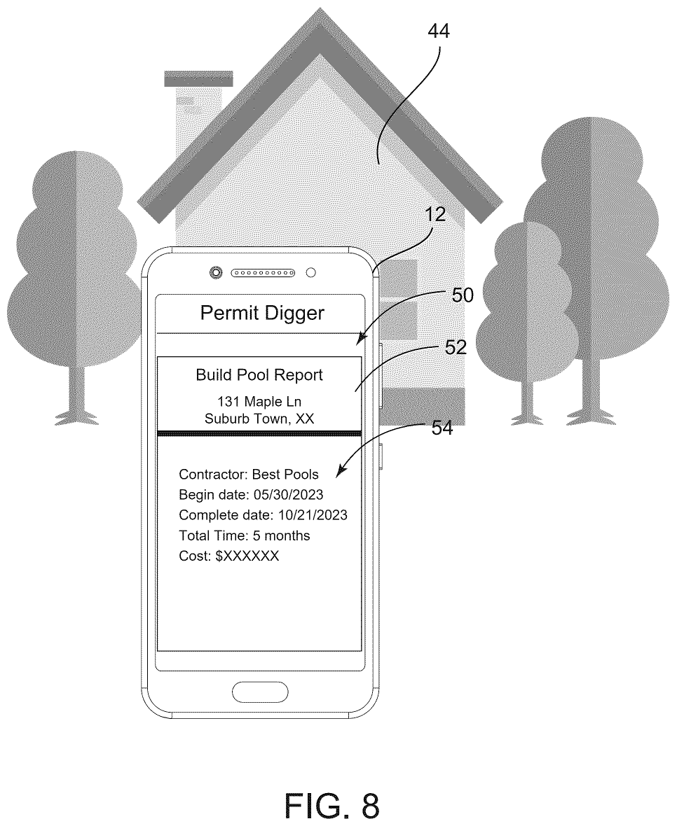

In response to the pressing of the “OPEN” button from the user computing device 12, the server 14 receives and processes a signal from the user computing device including the selected indicator 42 for the corresponding property 44 and generates and sends for display on the user computing device 12 a report corresponding to the selected property 44, as shown in FIG. 8. The user computing device 12 may display the report 52 on a report user interface 50. The report may include the address of the property 44 and details 54 of the construction/renovation project or projects that occurred at the property 44. The details 54 of the report 52 may include timing to complete projects, including time for permit to be granted and time until the permit is closed and project is completed. The details 54 may also include contractor and/or subcontractor information, cost information and aggregate the same to determine what contractors may be best in that area for a particular construction project type.

Additionally, the server 14 may include artificial intelligence (“AI”) programming that can identify trends and potential issues faced with certain project types based on analysis of historical data that had been aggregated on the memory of the server 14. Additionally, the AI programming may also have the ability to process profile information of the user, such as likes, dislikes, past searches and so forth to suggest permit data in areas, which is particularly helpful for certain purposes, like shopping for a home.

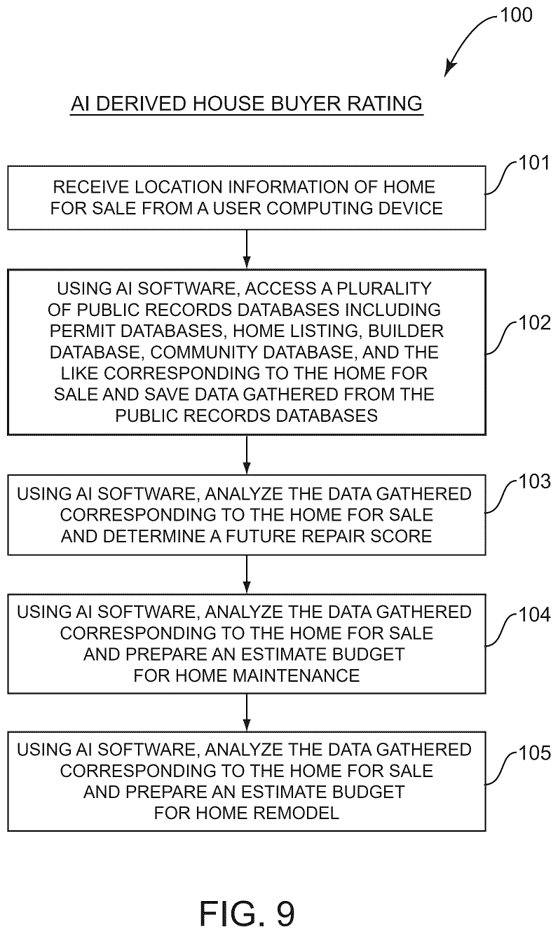

One example of operation of AI software utilization in the system 10 is depicted in FIG. 9. FIG. 9 depicts a flow chat of a method 100 of AI derived house buyer rating performed by the system 10. The method 100 may comprise receiving by the server location information of home for sale from a user computing device (Step 101); using AI software, access a plurality of public records databases including permit databases, social media commentary on permits, home listing, builder database, community database, overhead imagery and the like corresponding to the home for sale and save data gathered from the public records databases (Step 102); using AI software, analyze the data gathered corresponding to the home for sale and determine a future repair score (Step 103); using AI software, analyze the data gathered corresponding to the home for sale and prepare an estimate budget for home maintenance (Step 104); and using AI software, analyze the data gathered corresponding to the home for sale and prepare an estimate budget for home remodel (Step 105).

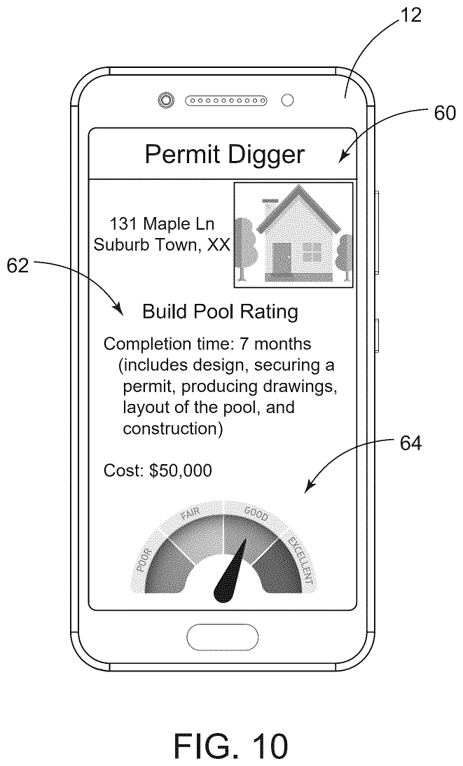

FIG. 10 depicts a home remodel score or rating, such as that described in Step 105 of the method 100, wherein the AI software analyzed the data gathered corresponding to the home for sale and prepared a report 60 that for adding a pool that include the timing to complete the pool construction that includes design time, permit securing time, drawing production, layout of the pool, and construction. The report further includes an estimate cost for the remodel and then provides a rating 64 based on the time and cost to complete the desired project, such as building a pool as shown in FIG. 10. The rating system may include any type of rating. Depicting in FIG. 10 is a scale of “POOR,” “FAIR,” “GOOD,” and “EXCELLENT.” The rating is determined as a predetermined difference of both timing to complete compared to a larger geographic average, such as a city, a state or a country and a predetermined difference in cost compared to a cost for the larger geographic average as described above. The greater the time over the average and the greater the cost over the average results in the scale moving from “EXCELLENT” to “POOR” with the “GOOD” and “FAIR” being predetermined differences between the “EXCELLENT” and “POOR” predetermined differences. The system 10 may provide the visual indicator 64 as shown in FIG. 10.

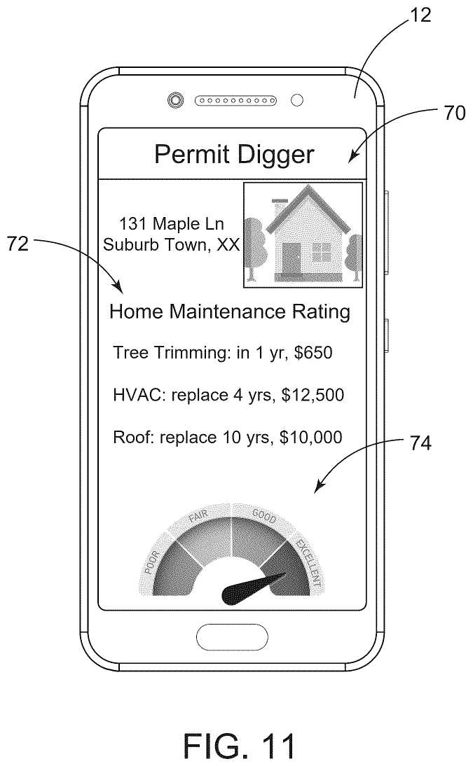

FIG. 11 depicts a maintenance score or rating, such as that described in Step 104 of method 100. Prior to the report generated and displayed as shown in FIG. 11, the AI software analyzed the data gathered, including the overhead imagery, corresponding to the home for sale and prepared a report 70 that for major maintenance that includes the estimate timing until the maintenance should be performed and an estimate cost for the maintenance in reporting data 72, and then provides a rating 74 based on the time and estimated cost for performing the maintenance. The AI software operates to determine cost based on historical costs for similar projects from public data bases and extrapolating the costs to account for increases due to elements such as, but not limited to, inflation, material availability and so forth. The rating system may include any type of rating. Depicted in FIG. 11 is a scale of “POOR,” “FAIR,” “GOOD,” and “EXCELLENT.” The rating is determined as a predetermined difference of both timing to complete compared to a larger geographic average, such as a city, a state or a country and a predetermined difference in cost compared to a cost for the larger geographic average as described above. The greater the time over the average and the greater the cost over the average results in the scale moving from “EXCELLENT” to “POOR” with the “GOOD” and “FAIR” being predetermined differences between the “EXCELLENT” and “POOR” predetermined differences. The system 10 may provide the visual indicator 74 as shown in FIG. 11.

In embodiments, the system 10 may include the options of rating the difficulty or ease of building in certain geographic areas, scoring for the building or remodeling in certain geographic areas. Further, the system may include the server 14 programmed to save certain properties 44 matching the criteria and allow the user computing device 12 to access the reports at a later time or even to send the report to the user through other means such as, but not limited to, email. Further still, other public records data may be gathered and aggregated, such as, but not limited to, insurance information.

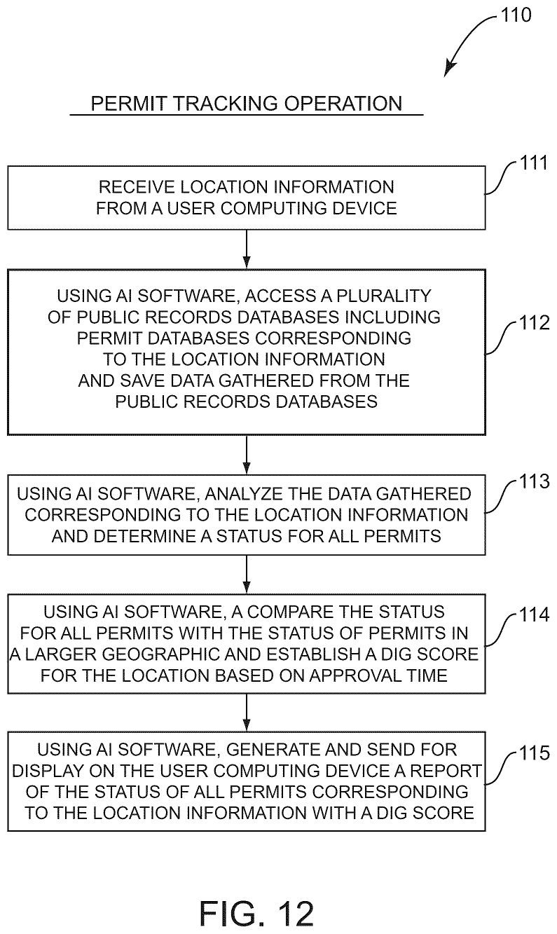

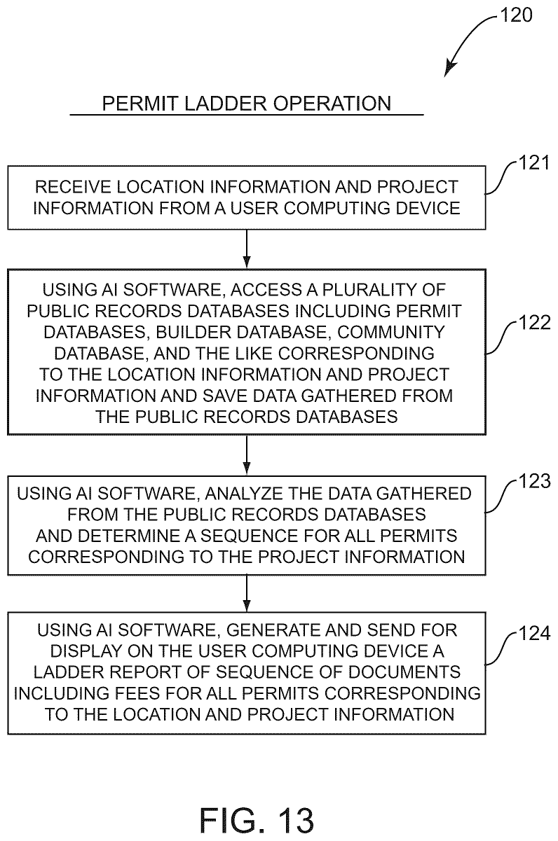

The system 10 may also operate to perform additional methods of generating reports relative to permits, such as the methods depicted in FIGS. 12 and 13. FIG. 12 depicts a method 110 of tracking permits in a geographic area. The server 14 may be programmed to implement method 110 comprising receiving location information from a user computing device (Step 111); using AI software, access a plurality of public records databases including permit databases corresponding to the location information and save data gathered from the public records databases (Step 112); using AI software, analyze the data gathered corresponding to the location information and determine a status for all permits (Step 113); using AI software, a compare the status for all permits with the status of permits in a larger geographic and establish a dig score for the location based on approval time (Step 114); and using AI software, generate and send for display on the user computing device a report of the status of all permits corresponding to the location information with a dig score (Step 115). The dig score may be determined based on a difference between the timing of permits being granted in a specific geographic area base on the location information compared to average times for a larger geographic area, such as, not limited to, a city, a state, or a country. The highest scores are at or near the average times for the larger geographic area and the lowest scores are beyond a predetermined larger difference between the times.

FIG. 13 depicts a method 120 of generating a permit ladder sequence in a geographic area. The server 14 may be programmed to implement the method 120 comprising receiving location information and project information from a user computing device (Step 121); using AI software, access a plurality of public records databases including permit databases, builder database, community database, and the like corresponding to the location information and project information and save data gathered from the public records databases (Step 122); using AI software, analyze the data gathered from the public records databases and determine a sequence for all permits corresponding to the project information (Step 123); and using AI software, generate and send for display on the user computing device a ladder report of sequence of documents including fees for all permits corresponding to the location and project information (Step 124). The ladder report of sequence of documents may include the order of what paperwork needs to come first and what needs to be filed with each amount of paperwork for each step in obtaining a permit, including the fees associated with each step if any. This allows the user to know what to expect and the timing of each step to avoid common mistakes and pitfalls that may be present in the permitting process.

### Curiosity Embodiment

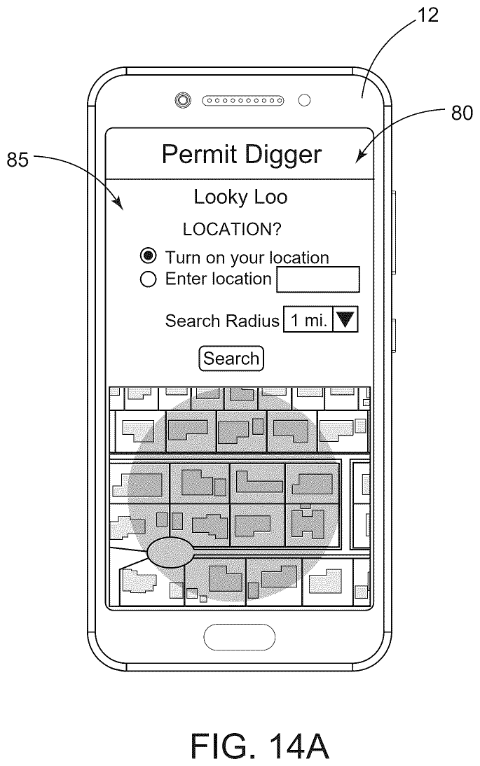

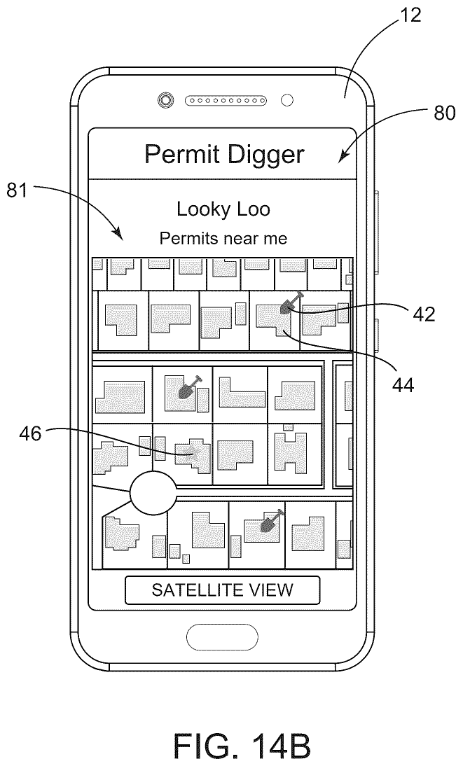

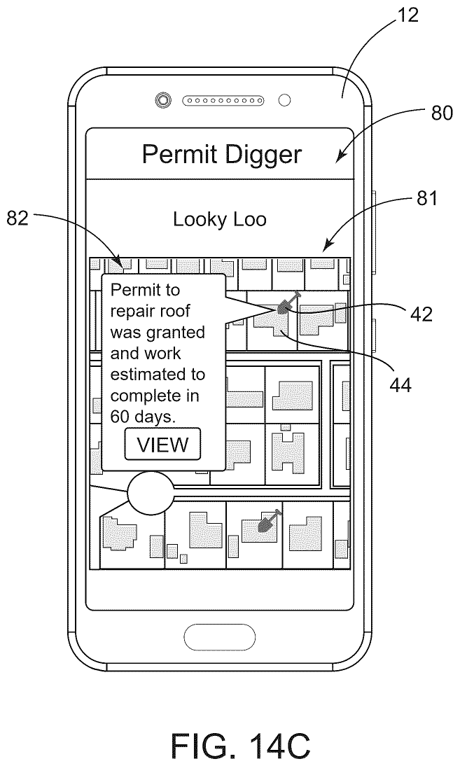

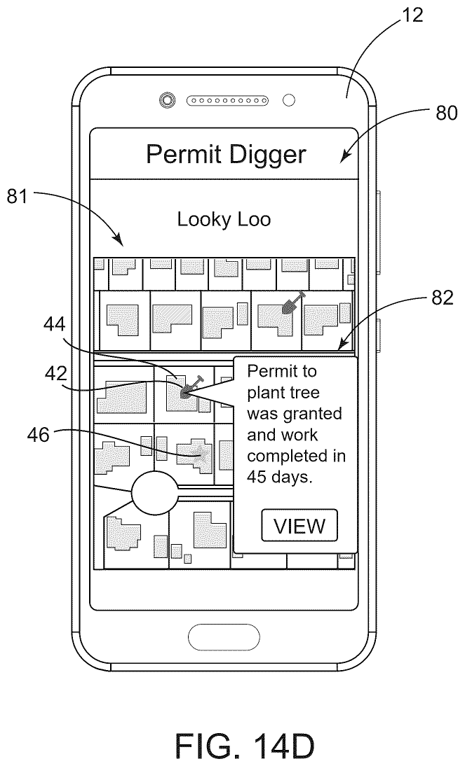

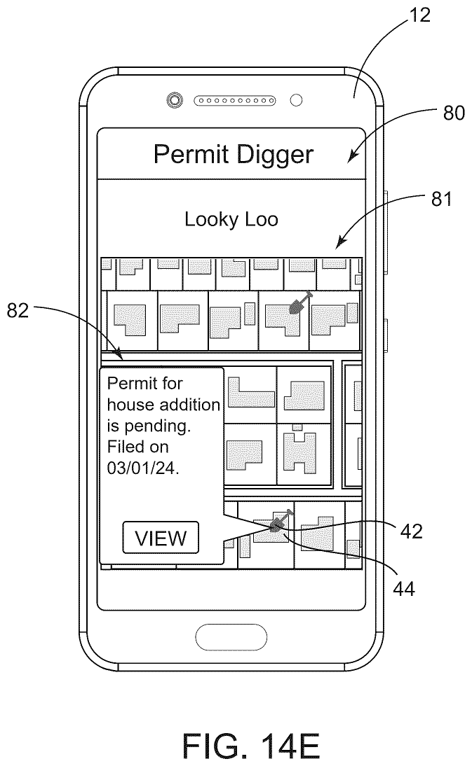

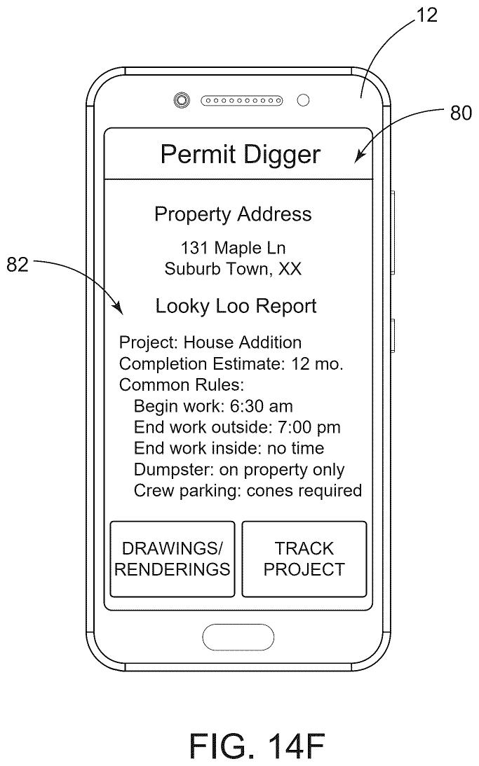

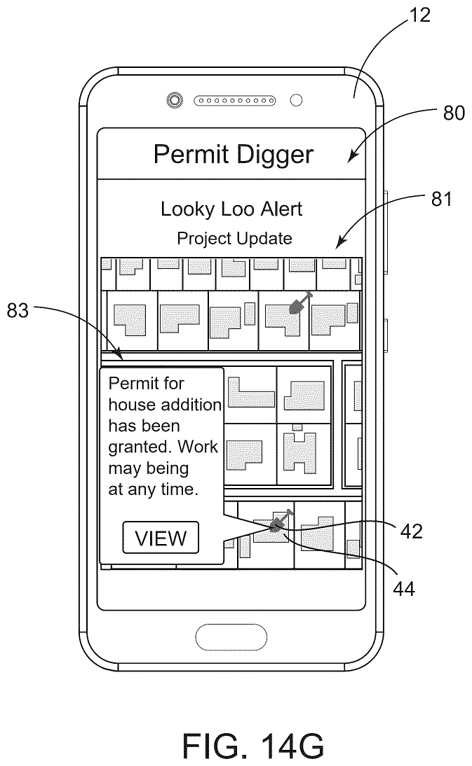

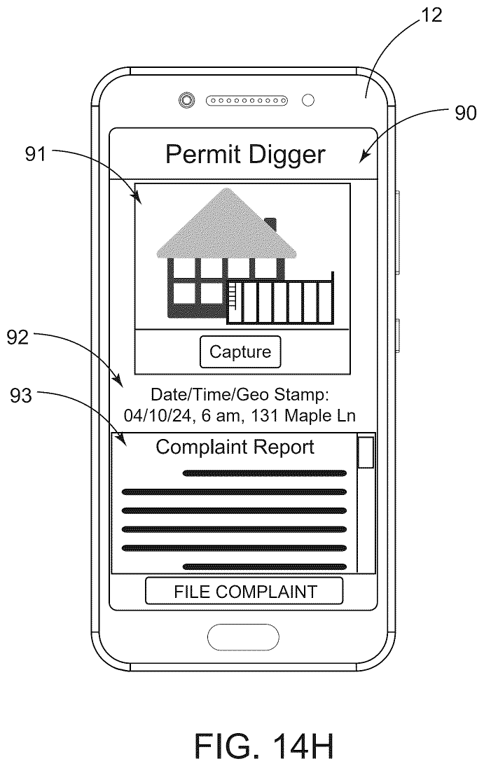

People are generally curious about what is happening around the area that they live. In particular, homeowners are curious as to what is happening in their own neighborhood. This extends to curiosity as to what construction, such as home additions, roof repair, landscaping, home painting and the like, occurring over time. This curiosity may be for reasons of seeking similar work to be done, but mostly it is curiosity to determine how this may affect the daily lives of the people. The system 10 may include an embodiment for curiosity purposes of curious people (looky loos), as depicted in FIGS. 14A-14H.

The server 14 may be programmed to receive and process a signal that a user computing device 12 has accessed the system 10 such as by an app, website or web app on the user computing device 12. In embodiments, when the user computing device accesses the system 10 a curiosity user interface 80 may be displayed on the user computing device 12, as shown in FIG. 14A. The curiosity user interface 80 may provide options for determining the location to be searched using location input item 85. Location input item 85 may include turning on the location services of the user computing device 12 or manually entering a location, such as an address, crossroads, zip code and the like. The curiosity user interface 80 may also include an input for a search radius around the location entered and may also include a map depiction showing a visual representation of the location and the radius selected by the user through the user computing device 12. The user may then select the “SEARCH” button on the query user interface 30. The selection of the “SEARCH” button results in the location data and query data obtained from the location input item 85 to be sent to the server.

The server 14 may then be programmed to receive and process the location data from the user computing device and automatically determine the permit data that corresponds to the location data. The server 14 may then be programmed to send for display on the user computing device 12 permit information including a map of the searched area with indicators identifying the location for the search and locations of where construction/renovation projects occurred matching the location data, as shown in FIG. 14B. Another page of the curiosity user interface 80 is shown in FIG. 14B, that includes map with indicator 42 identifying properties 44, such as homes, that the construction/renovation project is pending, already occurred or is currently underway. The indicator 42 may be a selectable element that the user can select through the curiosity user interface 80 on the user computing device 12. The curiosity user interface 80 may include a “SATELLITE VIEW” button that when selected results in the AI software operating on the server 14 to obtain and send for display on the user computing device 12 overhead satellite view of the search results. In response to a user selecting a selectable element and indicating the selection be sent to the server 14 from the user computing device 12, the server 14 may also be programmed to receive and process a signal from the user computing device including the selected indicator 42 for the corresponding property 44 and generate and send for display on the user computing device 12 a brief report corresponding to the selected property 44, as depicted in FIGS. 14C, 14D and 14E. For example, FIG. 14C depicts a project (roof repair in this example) that is currently under way in a brief report 83. AI software operates to generate the report, including calculating an estimated time for completion based on data stored in the server 14. This brief report 83 may be depicted in a window displayed over the map and identifying what indicator 42 the brief report 83 corresponds to. FIG. 14D depicts a completed project (planting a tree in this example) and may include the actual time for completion of the project. FIG. 14E depicts a project that is pending approval (house addition in this example), and the information may include a date the permit was filed and the current status of pending.

In each of the brief reports depicted in FIGS. 14C, 14D and 14E, the window includes a “VIEW” button that may be selected to view a more detailed report. For example, and without limitation, FIG. 14F depicts a more detailed report 83 of the brief report shown in FIG. 14E. The detailed report 82 may include information generated by the server 14 operating AI software. This information may include the project type, an estimated time for completion of the project based on AI analysis of the data stored on the memory of the server 14. Further still, the report 83 may include common rules for the project and the area the project is located. The AI software on the server 14 may operate to obtain and aggregate information to common rules from public record databases and/or other databases, such as a municipality rules. HOA rules, CC&R's and other community rules. The AI software may then analyze the rules obtained and aggregated and identify common rules or rules that are most relevant to users of the system 10. The curiosity user interface 80 in FIG. 14F may include a “DRAWINGS/RENDERINGS” button where the selection of the button results in the server 14 obtaining and sending for display on the user computing device 12, any drawings or renderings (not shown) corresponding to the project depicted in the report 83.

The curiosity user interface 80 in FIG. 14F may include a “TRACK PROJECT” button that when selected stores in the server 14 associated with a user's account for utilizing the system 10. The AI software operating on the server 14 may periodically check the status of the project that has been selected to be tracked. When a status changes, the AI software may operate to obtain and aggregate the status change and send for display on the user computing device an alert as depicted in FIG. 14G. The update may be a brief report 83 depicted over a map showing the location of the indicator 42 for the corresponding property 44 where the update has occurred. AI software operates to generate the report and may be depicted in a window displayed over the map and identifying what indicator 42 the brief report corresponds to.

If the user feels there is an issue with the work being done that does not match the rules returned in the report 82 (see FIG. 14F), the user may navigate to a complaint interface 90, as shown in FIG. 14H, to submit a complaint regarding the construction occurring, like parking violations, dumpster violation, noise violations at times designated as non-working times, and so forth. The server may be programmed with AI software, wherein the AI software operates to automatically obtain and populate all fields of a proper concern/complaint report 93, from public sources, and to submit to the municipality or controlling entity based on the public records data gathered and may also be based on an image, video and/or audio captured using the camera of the user computing device 12, through capture element 92 as shown in FIG. 14H. The complaint interface 90 may include date/time/geo-location stamp 92. The system 10 operates to automatically generate this stamp in order to preserve the and validate the report being filed. The complaint interface 90 allows a user to file the concern/complaint report 93 without needing to have all the know-how on which report and so forth needed to file such a report. AI software programmed in the server solves this aspect for the user. The report may be submitted to a community authority by the selection of the “FILE COMPLAINT” button. The community authority may be a municipality, an HOA or the like.

Embodiments may be available on or through the internet, such as through domain names reserved and owned by Applicant that include permitspot.ai, permitspot.com, permitpin.com, permitpin.ai, permithere.com, permithere.ai or the like.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire-line, optical fiber cable, RF, etc., or any suitable combination of the foregoing.

Computer program code for carrying out operations for aspects of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, cloud-based infrastructure architecture, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments and examples set forth herein were presented in order to best explain the present invention and its practical application and to thereby enable those of ordinary skill in the art to make and use the invention. However, those of ordinary skill in the art will recognize that the foregoing description and examples have been presented for the purposes of illustration and example only. The description as set forth is not intended to be exhaustive or to limit the invention to the precise form disclosed. Many modifications and variations are possible in light of the teachings above without departing from the spirit and scope of the forthcoming claims.

1. A permit aggregating and reporting system comprising:
a server having a memory for storing permit data;
a user computing device coupled to the server; and
one or more public record servers accessible by the server through the Internet, wherein the server is programmed to:
to access the one or more public records servers through the Internet and gather the permit data and store the permit data in the memory of the server;
couple the user computing device to the server in response to receiving and processing a signal that the user computing device has accessed the system by one of an app, a website or webapp operating on the user computing device;
receive and process the location data from the user computing device and automatically determine the permit data that corresponds to the location data;
send for display on the user computing device permit information including a map of the searched area with indicators identifying locations of where construction/renovation projects occurred matching the location data; and
receive and process a signal from the user computing device including a selected indicator for a corresponding property and generate and send for display on the user computing device a report corresponding to the selected property.

2. The system of claim 1, wherein the server is further programmed to receive and process query data from the user computing device, wherein the query data includes one or more specific construction/renovation projects.

3. The system of claim 2, wherein the server is further programmed to send for display on the user computing device permit information including the map of the searched area with indicators identifying locations of where construction/renovation projects occurred matching the location data and the query data.

4. A permit aggregating and reporting system comprising:
a server having a memory for storing permit data;
a user computing device coupled to the server; and
a plurality of public record servers accessible by the server through the Internet, the plurality of public record servers including two or more of permit databases, social media commentary, home listings databases, builder databases, community databases, and overhead imagery, wherein the server is programmed to:
to access the plurality of public records servers through the Internet and gather the permit data and store the permit data in the memory of the server;
couple the user computing device to the server in response to receiving and processing a signal that the user computing device has accessed the system by one of an app, a website or webapp operating on the user computing device;
receive and process the location data from the user computing device and automatically determine the permit data that corresponds to the location data;
send for display on the user computing device permit information including a map of the searched area with indicators identifying locations of where construction/renovation projects occurred matching the location data; and
receive and process a signal from the user computing device including a selected indicator for a corresponding property and using AI software generate and send for display on the user computing device a brief report corresponding to the selected property, wherein the brief report includes a status of all permits corresponding to the selected property.

5. The system of claim 4, wherein the server is further programmed to receive and process a signal from the user computing device including a request for a detailed report and using AI software process the permit data and generate and send for display on the user computing device a server generated estimate of time to complete the construction/renovation project and common rules and regulations regarding the construction/renovation project.

6. The system of claim 5, wherein the server is further programmed to periodically access the plurality of public records servers through the Internet and gather the permit data and aggregate the permit data stored in the memory of the server with updates to the permit data.

7. The system of claim 6, wherein the server is further programmed to send an alert to the user computing device when status of a permit for a property has changed in response to receiving a track project request from eh user computing device regarding the property.

8. The system of claim 5, wherein the server is further programmed to in response to receiving a request to file a complaint, send for display on the user computing device a complaint interface.

9. The system of claim 8, wherein the complaint interface includes a media capture element for capturing an image, a video and/or audio of a property.

10. The system of claim 9, wherein the server is further programmed to, using AI software, identify a property from the permit data corresponding to a location of the user computing device and automatically send for display in the complaint interface a date/time/geolocation stamp to verify the complaint relates to the property.

11. The system of claim 10, wherein the server is further programmed to, using AI software, obtain a proper complaint report form and automatically generate a complaint report for filing.
